(19) United States
(12) Patent Application Publication
(10) Pub. No.: US 2007/0253211 A1
(43) Pub. Date: Nov. 1, 2007

(54) Lamp structure

(75) Inventor: Cheng-Chung Chang, Hsi-Chih City (TW)

Correspondence Address: TROXELL LAW OFFICE PLLC, SUITE 1404, 5205 LEESBURG PIKE, FALLS CHURCH, VA, 22041, US

(73) Assignee: COLITEC Co., Ltd.

(21) Appl. No.: 11/414,200

(22) Filed: May 1, 2006

(51) Int. Cl. B60R 1/12; F21S 8/10

(52) U.S. Cl. 362/494; 362/545

(57) ABSTRACT

A lamp structure comprises a top fixture having a light-emitting device attached thereon; a frame body having a notch formed thereon; and a transparent cover, wherein the top fixture, the frame body, and the transparent cover are assembled together. As a result, a control wire of a video camera can be mounted easily by utilizing a wiring route of the light-emitting device via the notch of the frame body without damaging the original structure of the conventional lamp structure.

### FIELD OF THE INVENTION

The present invention relates to an improved lamp structure that makes the mounting of a video camera easier and is suitable for various vehicles or the likes.

### BACKGROUND OF THE INVENTION

By using the rearview mirrors mounted on both sides and the center of the vehicle, the driver can observe the surrounding images from the vehicle's seat. However, these rearview mirrors cannot reflect the images right behind the vehicle. In response to this, the vehicle is provided with the backing radar and the video camera. Besides, most vehicles are also provided with light sources above the license plates so as to show the license plate number clearly.

However, the conventional license plate light and video camera are mounted independently. Two wiring routes must be provided in order to assemble both of them. As a result, it takes a long time for attaching the light sources and the video camera to the vehicle. It means that this vehicle is not available for a certain period of time and the wiring cost is unavoidably very high. Moreover, the conventional backing radar is generally mounted on the center of the bumper or on the top of the vehicle. Moreover, when the video camera is mounted on the bumper, it is damaged easily by careless backing or hit from behind by the rear vehicle.

However, the video camera is optimally located away from the ground so as to monitor the area between the bumper and the barriers. As a result, for a compact vehicle, the video camera is preferably mounted above the bumper. In consideration of the hiding effect and appearance, the video camera is best mounted above the outer frame of license plate. Besides, the driver still needs to take the required time, the convenience, and the damage degree of the wiring of the video camera and the waterproofness of the mounting location into consideration.

Whereas the foregoing description, the present inventor makes diligent studies in providing the consumers with an improved lamp structure that makes the wiring of the video camera easier and can be mounted rapidly.

### SUMMARY OF THE INVENTION

It is a main object of the present invention to provide an improved lamp structure such that a control wire of a video camera can utilize a wiring route of the lamp structure without damaging the original structure of the conventional lamp structure.

It is another object of the present invention to provide an improved lamp structure that makes the mounting and wiring of the video camera easier.

In order to achieve the above-mentioned objects, a lamp structure comprises a top fixture having a light-emitting device attached thereon; a frame body having a notch formed thereon; and a transparent cover, wherein the top fixture, the frame body, and the transparent cover are assembled together. As a result, a control wire of a video camera can be mounted easily by utilizing a wiring route of the light-emitting device via the notch of the frame body without damaging the original structure of the conventional lamp structure.

The aforementioned objects and advantages of the present invention will be readily clarified in the description of the preferred embodiments and the enclosed drawings of the present invention.

### BRIEF DESCRIPTION OF THE DRAWINGS

FIG. 1 is a three-dimensional view showing a first preferred embodiment of the present invention.

FIG. 2 is an exploded view showing the components of the first preferred embodiment of the present invention.

FIG. 3 is a schematic view showing the usage of the first preferred embodiment of the present invention.

FIG. 4 is a cross-sectional view of FIG. 3.

FIG. 5 is an exploded view showing the components of a second preferred embodiment of the present invention.

FIG. 6 is a three-dimensional view showing the second preferred embodiment of the present invention.

### DETAILED DESCRIPTION OF THE PREFERRED EMBODIMENT

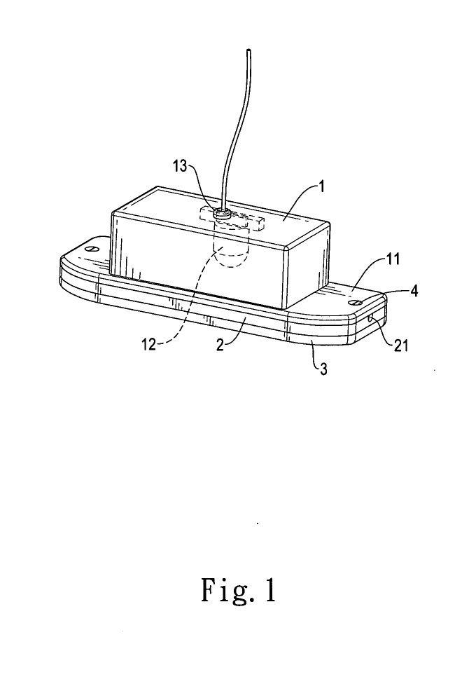

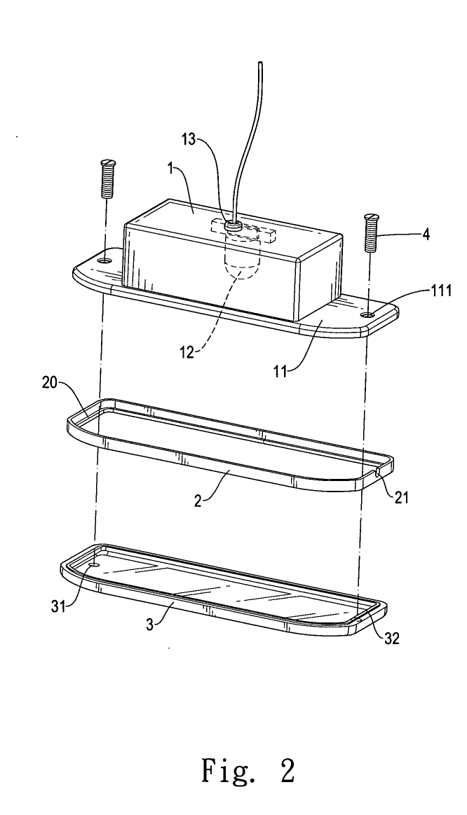

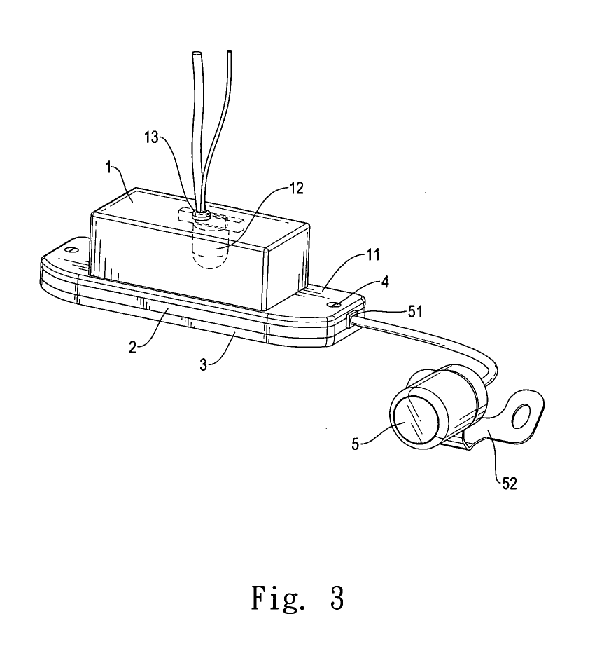

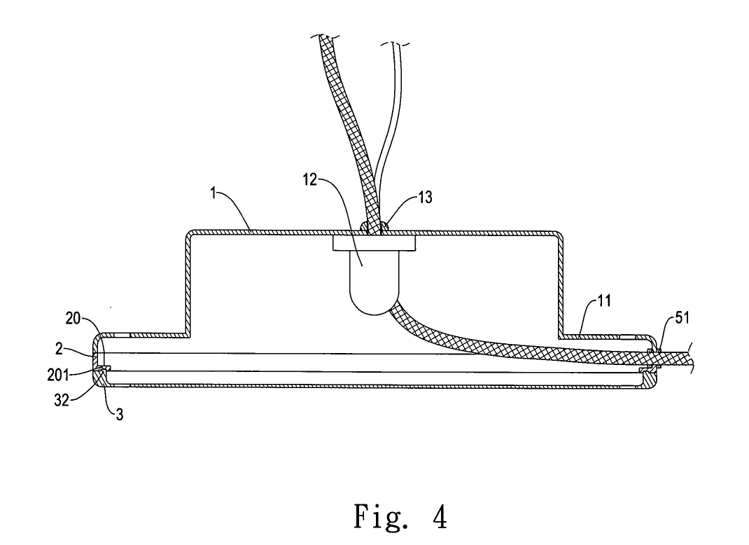

Referring to FIG. 1 through FIG. 4 simultaneously, a first preferred embodiment of a lamp structure of the present invention is shown. The lamp assembly comprises a top fixture, which is a top box 1 in this preferred embodiment, a frame body 2, and a transparent cover 3. A wire hole 13 is formed on the center of the top box 1. A light-emitting device 12 is coupled to the inside of top box 1, wherein the light-emitting device 12 is such as a light bulb or a light-emitting diode. A wire of the light-emitting device 12 is extended to the outside of the top box 1 via the wire hole 13. A protrudent flange 11 is extended horizontally from an opening of the top box 1. A coupling hole 111 is formed on both sides of the protrudent flange 11, respectively.

The frame body 2 has a shape conformal to the protrudent flange 11. A notch 21 is formed on one side of the frame body 2. A horizontal extension flange 20 is located inwardly on the other side of the frame body 2. In addition, a trench 201 is formed on the extension flange 20.

The transparent cover 3 is also conformal to the protrudent flange 11 located on the opening of the top box 1, wherein a protrudent flange 32 is located on the inner periphery of the transparent cover 3. A coupling hole 31 is formed oppositely on both sides of the transparent cover 3, respectively.

After alignment, the protrudent flange 32 located on the inner periphery of the transparent cover 3 is embedded into the trench 201 of the extension flange 20 of the frame body 2 so as to securely position the frame body 2. Next, the transparent cover 3 and the frame body 2 are attached to the opening of the top box 1 together. Next, two screws 4 are respectively screwed into the coupling holes 111 of the protrudent flange 11 and the coupling holes 31 of the transparent cover 3 so as to complete the assembly of the present invention and permit the light emitted from the light-emitting device 12 to pass through the transparent cover 3.

When in use, the top box 1 on which the above-mentioned components are mounted is attached above a license plate on the backside of the vehicle such that the license plate can be illuminated by the light emitted from the light-emitting device 12 so as to show the license plate number clearly. If there is a need to mount a video camera 5, these two screws 4 must be unscrewed for separating the top box 1, the transparent cover 3, and the frame body 2. Thereafter, a control wire of the video camera 5 is inserted into the wire hole 13 and a fixing block 51 located on the control wire is embedded into the notch 21 of the frame body 2. Thereafter, the top box 1, the frame body 2, and the transparent cover 3 are reassembled together by using the screws 4 such that the fixing block 51 of the video camera 5 is confined between the protrudent flange 11 of the top box 1 and the notch 21 of the frame body 2. In addition, the video camera 5 can be attached to the backside of the vehicle beside the license plate properly by using a coupling fixture 52 mounted on the bottom of the video camera 5.

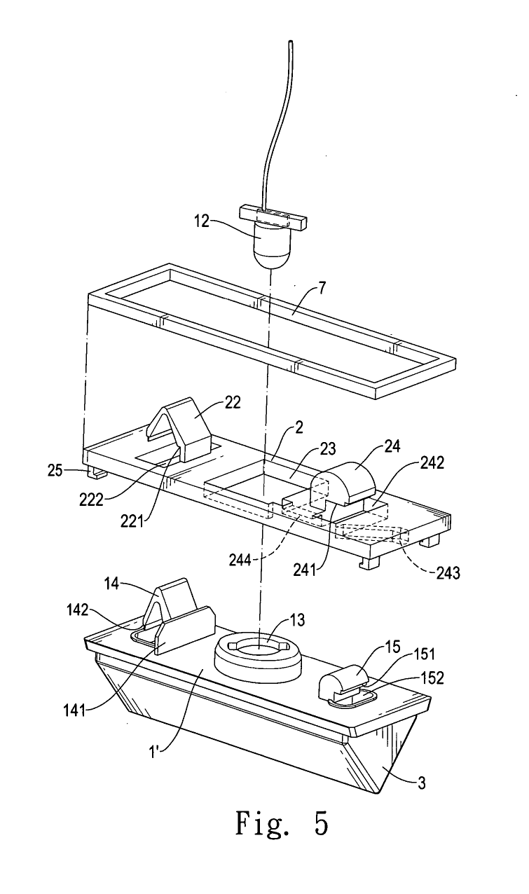

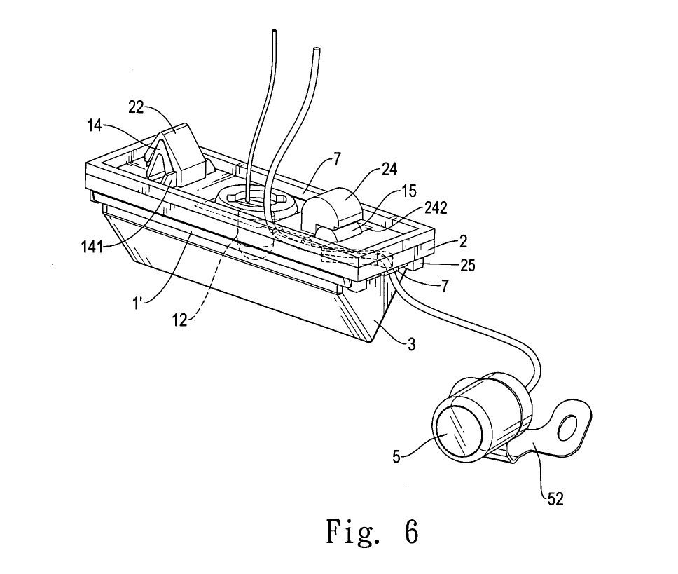

Referring further to FIG. 5 and FIG. 6, a second preferred embodiment of the present invention is shown. The lamp structure comprises a top fixture, a frame body 2, and a transparent cover 3. In this preferred embodiment, the top fixture is a top plate 1′ on which a wire hole 13 is formed on the center thereof. A triangular protrudent block 14 is mounted on one end of the top plate 1′. In addition, a fixing plate 141 is mounted on the backside of the protrudent block 14, wherein a stair-shaped fixture 142 is located on the front end of the protrudent block 14. A protrudent block 15 having an arc-shaped top is mounted on the other end of the top plate 1′, wherein an inward sunken trench is formed on one side of the bottom of the protrudent block 15. In addition, a stair-shaped fixture 151 is mounted on the edge of the protrudent block 15, wherein a through hole 152 is formed on the top plate I′ under the stair-shaped fixture 151.

The frame body 2 is conformal to the top plate 1′. A square through hole 23 is formed on the center of the frame body 2. A slight triangular fixing block 22 is attached to and protruded from one end of the frame body 2, wherein a stair-shaped fixture 221 is mounted on the attached side of the fixing block 22. In addition, an opening 222 is formed on the frame body 2 under the fixing block 22.

A fixing block 24 having an arc-shaped top is mounted on the other end of the frame body 2, wherein an inward sunken trench is formed on one side of the bottom of the fixing block 24 so as to form a pressing flange 241 on the same side of the fixing block 24. In addition, an opening 242 is formed on the frame body 2 under the pressing flange 241, wherein two opposite notches 243 and 244 are formed on the frame body 2 under the opening 242, respectively. The notch 244 communicates with the through hole 23. In addition, several bottom hooks 25 are located on the bottom periphery of the frame body 2.

The transparent cover 3 has an opening conformal to the opening of the top plate 1′, and the transparent cover 3 also has two inward-slanted side plates adjacent to the long edges of the opening, respectively, such that the transparent cover 3 has a triangular pyramidal form.

The opening of the transparent cover 3 is coupled with the top plate 1′ from the lower position. The light-emitting device 12 is inserted into the transparent cover 3 via the wire hole 13 of the top plate 1′, wherein the control wire of the video camera 5 is guided to pass through the notch 243, the opening 242, and the notch 244 in sequence so as to stretch out the control wire from the through hole 23. Thereafter, the frame body 2 is located on the top of the top plate 1′ so as to insert the protrudent block 14 into the opening 222, insert the protrudent block surrounding the wire hole 13 into the through hole 23, and insert the protrudent block 15 into the opening 242. Thereafter, the frame body 2 and the top plate 1′ are pressed to couple with each other such that the stair-shaped fixtures 142 and 151 can exactly touch the top corners of the openings 222 and 242 of the frame body 2, respectively, for further hooking the top plate 1′ by using the bottom hooks 25. As a result, the control wire of the video camera 5 is confined between the notch 243 and the top plate 1′. Thereafter, a waterproof gasket 7 is attached to the top of the frame body 2 and the notch 243, whereby the assembly of the present invention is complete.

In accordance with the foregoing description, it is apparent that the lamp structure of the present invention provides the advantages of:

1. permitting the control wire of the video camera to pass through the case of the lamp structure without damaging the original structure of the conventional lamp structure by additionally using the frame body; and

2. combining the wiring routes of the video camera and the lamp structure such that the period of construction can be shortened and the cost of construction can be reduced as well.

In summary, the present invention indeed achieves the expected objects of providing the lamp structure that enables the video camera to be mounted easily. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A lamp structure comprising:
a top fixture having a light-emitting device attached thereon;
a frame body having a notch formed thereon; and
a transparent cover, wherein the top fixture, the frame body, and the transparent cover are assembled together, whereby a control wire of a video camera can be guided to pass through the notch of the frame body to be stretched out with a wire of the light-emitting device for aiding the wiring of the control wire of the video camera.

2. The lamp structure of claim 1, wherein the top fixture is a top box having a wire hole on a center region thereof for being passed through by the wire of the light-emitting device and a protrudent flange extended horizontally from an opening of the top box, wherein the frame body is conformal to the protrudent flange of the top box and has an extension flange having a trench at a bottom edge thereof, and wherein the transparent cover is also conformal to the protrudent flange located on the opening of the top box and has a protrudent flange located on an inner periphery thereof for mounting the frame body.

3. The lamp structure of claim 2, wherein a plurality of coupling holes are respectively formed on the protrudent flange of the top box and the transparent cover for being penetrated by a plurality of screws, respectively.

4. The lamp structure of claim 1, wherein the top fixture is a top plate having a wire hole protrudent from a center region thereof, a first protrudent block and a fixing plate on one side of the wire hole, a second protrudent block and a through hole on the other side of the wire hole, wherein the transparent cover is coupled to the bottom of the top plate, wherein the frame body is conformal to the top plate and has a plurality of bottom hooks and the notch on the bottom thereof for hooking the top plate by using the bottom hooks.

5. The lamp structure of claim 4, wherein the transparent cover has two opposing side plates slanted inward to a center region thereof.

6. The lamp structure of claim 4, wherein a through hole for being penetrated by the wire hole of the top plate is formed on a center region of the frame body, an opening is formed on both sides of the through hole, respectively, a fixing block with a shape identical to that of the first and second protrudent blocks of the top plate is mounted beside the openings, respectively, and a stair-shaped fixture is mounted on one of the fixing blocks for positioning the fixing plate.

7. The lamp structure of claim 6, wherein an open-bottomed notch is formed oppositely at bottom edges on both sides of one of the openings of the frame body, respectively.

8. The lamp structure of claim 7, wherein a waterproof gasket is attached to the notch on the outside of the opening.

9. The lamp structure of claim 4, wherein a stair-shaped fixture is mounted on the first and second protrudent blocks of the top plate, respectively.

10. The lamp structure of claim 4, wherein a waterproof gasket is attached to the top of the frame body.
